(19) United States
(12) Patent Application Publication
(10) Pub. No.: US 2004/0110907 A1
(43) Pub. Date: Jun. 10, 2004

(54) Powder coating compositions for coatings with a matt apperance

(75) Inventors: Joern Volker Weiss, Haltern am See (DE); Werner Grenda, Herne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSA AG, Duesseldorf (DE)

(21) Appl. No.: 10/724,830

(22) Filed: Dec. 2, 2003

(30) Foreign Application Priority Data
Dec. 7, 2002 (DE) 102 57 217.8

(51) Int. Cl. C08G 63/00

(52) U.S. Cl. 525/437; 525/440

(57) ABSTRACT

Powder coating compositions based on carboxyl- and/or hydroxyl-containing polyesters, crosslinkers, and other customary additives for coatings having a matt appearance and methods for providing coatings having a matt appearance.

### BACKGROUND OF THE INVENTION

1. Field of the Invention

The invention relates to powder coating compositions based on carboxyl- and/or hydroxyl-containing polyesters, crosslinkers, and other customary additives for coatings having a matt appearance.

2. Discussion of the Background

Coating systems and processes which give a substrate a uniformly even and matt surface are of considerable interest. The reasons for this are predominantly practical in nature. Glossy surfaces require a far greater degree of cleaning than matt surfaces. Furthermore, it may be desirable on safety grounds to avoid strongly reflecting surfaces.

The simplest method of obtaining a matt surface is to admix smaller or larger amounts of fillers, such as chalks, finely divided silica or barium sulfate, for example, to the powder coating material in accordance with the extent of the desired matt effect. Such additions, however, result in a deterioration in the film properties of the coating, such as adhesion, flexibility, impact strength and chemical resistance.

The addition of substances incompatible with the coating material, such as waxes or cellulose derivatives, for example, clearly gives rise to matting, but slight changes in the course of extrusion lead to fluctuations in the surface gloss. The reproducibility of the matt effect of coatings obtained from such coating materials is not ensured.

Polyester powder coating materials are materials comprising acidic polyester binders and crosslinkers containing reactive glycidyl and/or hydroxyalkylamide groups. Common commercial crosslinkers, employed worldwide, include triglycidyl isocyanurate (TGIC) and β-hydroxyalkylamide and their derivatives. Powder coating materials based on hydroxyl-containing polyesters are not covered by the general term “polyester powder coating materials”. Since they are crosslinked exclusively with polyisocyanates, they constitute the group of the polyurethane powder coating materials.

Both polyester and polyurethane powder coating materials result in weathering-stable coating systems, i.e., they can be used for outdoor applications and consequently are of great industrial and economic importance. The possibilities for the matting of both systems have formed the subject of numerous publications and patents, e.g., DE-A 196 30 844, DE-A 196 37 375, DE-A 196 37 377, DE-A 198 16 547, EP 0 698 645 and R. Franiau, Advances in β-hydroxy-alkylamide crosslinking chemistry, ECJ (2002) 10, p. 409.

In DE-A 100 42 318 matt polyurethane powder coating materials are described which are composed of defined hydroxyl-containing polyesters, customary commercial polyisocyanate crosslinkers, and special, separately prepared polyurea matting agents. The matting of the system is achieved through the use of defined hydroxyl-containing polyesters in combination with polyureas.

DE 102 33 103 describes matt polyurethane powder coating materials comprising defined combinations of amorphous and/or (semi)crystalline polyesters, polyureas, crosslinkers, and customary auxiliaries and additives.

These matting strategies also hold for polyester powder coating materials if instead of amorphous and crystalline hydroxyl-functionalized polyesters the corresponding carboxyl-containing polyesters are used in combination with polyureas and, where appropriate, other fillers, as described in DE 102 55 250.

Surprisingly it has now been found that amorphous polyesters, with both OH and COOH functionalization, together with highly specific (semi)crystalline polyesters, likewise with both OH and COOH functionalization, when used in the corresponding polyurethane and polyester powder coating systems even without the addition of polyurea and/or other fillers, lead to matt coatings.

### SUMMARY OF THE INVENTION

Accordingly, an object of the present invention is to provide powder coating compositions for coatings having a matt appearance, containing at least

A) a crosslinker component

and

B) a polyester component containing COOH groups and/or OH groups, comprising

B1) from 10 to 80% by weight of at least one amorphous polyester based on the total weight of the polyester composition,

B2) from 20 to 90% by weight of at least one (semi)crystalline polyester obtained by reacting from 50 to 100 mol % of succinic and/or adipic and/or sebacic and/or dodecanedioic acid and/or anhydride and/or ester and from 50 to 100 mol % of monoethylene glycol, butane-1,4-diol and/or hexane-1,6-diol,

the polyester having an OH number of from 0 to 200 mg KOH/g and an acid number of from 0 to 150 mg KOH/g, with at least one number being greater than zero, there being from 0.6 to 1.2 reactive groups of the crosslinker available per functional group of the polyester.

The powder coating compositions may also contain C) 0.5-50% by weight of auxiliaries and additives.

With regard to the polyester B) it is essential to the invention that it comprise a mixture of 40-80% by weight, preferably 60-70% by weight, of at least one amorphous polyester B1) and 20-60% by weight, preferably 30-40% by weight, of at least one (semi)crystalline polyester B2).

The carboxyl-containing and hydroxyl-containing polyesters are prepared by polycondensing suitable dicarboxylic and/or polycarboxylic acids, esters and/or anhydrides and diols and/or polyols. The condensation is accomplished in a conventional manner in an inert gas atmosphere at temperatures from 100 to 260° C., preferably from 130 to 220° C., in the melt or in an azeotropic regime, as described, for example, in Methoden der Organischen Chemie (Houben-Weyl); Volume 14/2, pages 1 to 5, 21 to 23, 40 to 44, Georg Thieme Verlag, Stuttgart, 1963 (incorporated herein by reference), or in C. R. Martens, Alkyd Resins, pages 51 to 59, Reinhold Plastics Appl. Series, Reinhold Publishing Comp., New York, 1961 (incorporated herein by reference).

The amorphous polyesters B1) used in accordance with the invention preferably have a COOH and/or OH number of 15-200 mg KOH/g, a glass transition temperature (Tg) of 35-85° C., a melting range of 60 to 110° C., and a hydroxyl and/or acid number of <10 mg KOH/g. The molar masses are preferably from 2,000 to 7,000.

The carboxylic acids preferred for preparing the polyesters can be aliphatic, cycloaliphatic, aromatic and/or heterocyclic in nature and where appropriate can be substituted by halogen atoms and/or unsaturated. Examples of such carboxylic acids include the following: succinic, adipic, suberic, azelaic, sebacic, phthalic, terephthalic, isophthalic, trimellitic, pyromellitic, tetrahydrophthalic, hexahydrophthalic, hexahydroterephthalic, dichlorophthalic, tetrachlorophthalic, endomethylenetetrahydrophthalic, glutaric, and 1,4-cyclohexane-dicarboxylic acid, and also, where available, their anhydrides or esters. Those specially suitable are isophthalic acid, terephthalic acid, hexahydroterephthalic acid, and 1,4-cyclohexanedicarboxylic acid. A single carboxylic acid or a mixture of carboxylic acids may be used.

Examples of suitable polyols include monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydroxymethyl)cyclohexane, 2,2-bis(4-hydroxycyclohexyl)propane, 2,2-bis[4-(β-hydroxyethoxy)phenyl]propane, 2-methyl-propane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl) isocyanurate, pentaerythritol, mannitol and sorbitol, and also diethylene glycol, triethylene glycol, tetraethylene glycol, dipropylene glycol, polypropylene glycols, polybutylene glycols, xylylene glycol and neopentylglycol hydroxypivalate. Particular preference is possessed by monoethylene glycol, neopentylglycol, Dicidol, cyclohexanedimethanol, trimethylolpropane, and glycerol. A single polyol or a mixture of different polyols may be used.

The (semi)crystalline polyesters B2) generally have a COOH and/or OH number of 15-150 mg KOH/g; the melting points are between 60 and 130° C., the glass transition temperature is <−10° C., and the weight average molecular weight is between 1,800 and 6,500. These polyesters are based on linear dicarboxylic acids and aliphatic or cycloaliphatic, linear or branched polyols. Suitable dicarboxylic acids include succinic acid, which is preferred, and/or adipic acid and/or sebacic acid and/or dodecanedioic acid in amounts of at least 50 mol %, preferably of at least 85 mol %, based on the total amount of all carboxylic acids. In this invention the expression “dicarboxylic acid” always includes the corresponding esters, anhydrides, and acid chlorides, since they too can naturally be used. In significantly lower fractions of up to a maximum of 50 mol %, preferably up to 15 mol %, it is possible to use other aliphatic, cycloaliphatic or aromatic dicarboxylic acids. Examples of dicarboxylic acids of this kind are glutaric acid, azelaic acid, 1,4-, 1,3- or 1 ,2-cyclohexanedicarboxylic acid, terephthalic acid and isophthalic acid. The polyol component used for the (semi)crystalline polyesters comprises monoethylene glycol and/or butane-1,4-diol, which is preferred, and/or hexane-1,6-diol in amounts of at least 50 mol %, preferably 80 mol %, based on the total amount of all polyols. In amounts of not more than 50 mol %, preferably 20 mol %, it is possible if desired to use other aliphatic or cycloaliphatic, linear or branched polyols. Examples of such polyols are diethylene glycol, neopentylglycol hydroxypivalate, neopentylglycol, cyclohexanedimethanol, pentane-1,5-diol, pentane-1,2-diol, nonane-1,9-diol, trimethylolpropane, glycerol and pentaerythritol. The semicrystalline polyester may contain a single carboxylic acid and/or polyol or mixtures of different carboxylic acids and/or polyols.

As crosslinkers A) for the COOH-functionalized polyesters it is possible in principle to use one or more of any known crosslinkers based on polyepoxides (TGIC and derivatives) and polyhydroxyalkylamides for the powder coatings sector. Preference is given to commercial products such as ARALDIT PT 810, PT 910, PT 912 (Vantico), PRIMID 552, QM 1260, SF 4510 (Ems) and VESTAGON HA 320 (Degussa) and also PROSID H, S (SIR).

β-Hydroxyalkylamides are particularly preferred. They are described for example in EP 957 082, EP 649 890, EP 322 834, EP 322 807, EP 262 872, U.S. Pat. No. 4,076,917 (the disclosure of each of these documents describing β-hydroxy alkylamides is incorporated herein by reference).

One preferred embodiment of the invention uses the following 13-hydroxyalkylamides A):

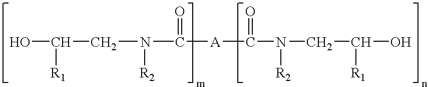

where R₁ is hydrogen, an aromatic radical or a C₁-C₅ alkyl group, R₂ is hydrogen, an aromatic radical, a C1-C5 alkyl group or

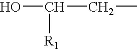

and A is a chemical bond or a monovalent or polyvalent organic group selected from saturated, unsaturated and aromatic hydrocarbon groups, and substituted hydrocarbon groups having 2 to 20 carbon atoms, m is 1 to 2, n is 0 to 2 and m+n is at least 1. With particular preference these compounds having a functionality of four. The β-hydroxyalkylamides are present preferably in amounts of 2-10% by weight, more preferably 3-5% by weight.

As crosslinkers A) for the OH-functionalized polyester mixtures B) it is possible in principle to use all known crosslinkers having a functionality of at least 1.7 based on polyisocyanates for the powder coatings sector. Preference is given to using not only polyisocyanates containing blocking agents but also internally blocked polyisocyanates. They are described for example in DE-OSS 21 05 777, 25 42 191, 27 35 497, 30 39 824, 30 30 572, 30 30 513 and 37 39 549 (those portions of each that is relevant to crosslinkers for the invention coating composition are incorporated herein by reference).

Isocyanates used for preparing the crosslinker component A) are diisocyanates of aliphatic and (cyclo)aliphatic and/or cycloaliphatic structure. Such diisocyanates are described for example in Houben-Weyl, Methoden der Organischen Chemie, Volume 14/2, p. 61 ff and in J. Liebigs Annalen der Chemie, Volume 562, p. 75-136 (incorporated herein by reference). Preference is generally given to using the readily industrially available aliphatic diisocyanates such as hexamethylene diisocyanate (HDI), 2-methylpentamethylene 1,5-diisocyanate, 2-ethyltetramethylene 1,4-diisocyanate or trimethylhexamethylene 1,6-diisocyanate (TMDI), especially the 2,2,4 and the 2,4,4 isomer and technical-grade mixtures of both isomers, the (cyclo)aliphatic diisocyanates such as isophorone diisocyanate (IPDI), and the cycloaliphatic diisocyanates such as 4,4′-diisocyanatodicyclohexylmethane (HMDI) or norbomane diisocyanate. By (cyclo)aliphatic diisocyanates the skilled artisan understands NCO groups attached at the same time to cyclic and aliphatic structures, as is the case with isophorone diisocyanate for example. These are contrasted with cycloaliphatic diisocyanates containing only NCO groups attached directly to the cycloaliphatic ring.

In order to prepare the crosslinker component A) containing urethane groups into a reaction chamber the diisocyanate is first reacted with the polyol in a first stage of preparation. The diisocyanate is introduced initially at from 100 to 120° C. and then the polyol is metered in over the course of 2 to 3 hours under nitrogen, in the absence of moisture and with intensive stirring, in such a way that at least 2 but not more than 8, preferably from 4 to 6, equivalents of diisocyanate NCO react per polyol OH equivalent. To accelerate the reaction it is possible to add a conventional urethanization catalyst, examples of which include organotin compounds and also certain tertiary amines, such as triethylenediamine, in an amount of from 0.01 to 1% by weight, preferably from 0.05 to 0.15% by weight, based on the reaction mixture.

In a second stage of preparing the crosslinker component A) the NCO groups are blocked with a blocking agent. The reaction can be carried out without solvent or else in the presence of suitable (inert) solvents. It is preferred, however, to operate without solvent. When carried out in the absence of a solvent the blocking agent is added in portions to the polyol-diisocyanate adduct at from about 100 to 130° C. and at a rate such that the temperature does not rise above 140° C. When the blocking agent has been added the reaction mixture is heated at 130° C. for about 1 to 2 h in order to complete the reaction. The blocking agent is added in amounts such that from 0.7 to 1.1 mol of blocking agent, preferably 1 mol, reacts per NCO equivalent of the urethanized diisocyanate.

Suitable polyols for reacting with the diisocyanate in the first stage of the preparation process are all of the polyols known to polyurethane chemistry, including ethylene glycol, propane-1,3-diol, butane-1,4-diol, pentane 1,5-diol, 3-methylpentane-1,5-diol, hexane-1,6-diol, 2,2,4(2,4,4)-trimethylhexane-1,6-diol, 1,4-di(hydroxymethyl)cyclohexane, diethylene glycol, triethylene glycol, diethanolmethylamine, neopentylglycol, triethanolamine, trimethylolpropane, trimethylolethane, glycerol and pentaerythritol for example. A single polyol or mixtures of different polyols may be used.

In one advantageous variant of the preparation process the preparation sequence of the blocked diisocyanate adducts is reversed: in the first stage the diisocyanate is reacted partially with the blocking agent, followed in the second stage by the reaction with the polyol.

The particularly preferred diisocyanate for preparing the crosslinker component A) containing urethane groups is isophorone diisocyanate.

The abovementioned diisocyanates are also used for preparing the trimers (isocyanurates). The trimers are prepared conventionally in accordance with GB-B 13 91 066 and DE-CS 23 25 826, 26 44 684, and 29 16 201 (those portions of each which is relevant to the preparation of isocyanurates are incorporated herein by reference). The products of these processes are isocyanato isocyanurates which may contain higher oligomers. They have an NCO content of from 10 to 22% by weight.

In the crosslinker component A) containing urethane and isocyanurate groups the ratio of the urethane groups to the isocyanurate groups can be set arbitrarily in order to achieve a desired effect.

Any blocking agent can be used to block the isocyanate groups of the crosslinker component A). By way of example it is possible to use phenols such as phenol and p-chlorophenol, alcohols such as benzyl alcohol, oximes such as acetone oxime, methyl ethyl ketoxime, cyclopentanone oxime, cyclohexanone oxime, methyl isobutyl ketoxime, methyl tert-butyl ketoxime, diisopropyl ketoxime, diisobutyl ketoxime or acetophenone oxime, N-hydroxy compounds such as N-hydroxysuccinimide or hydroxypyridines, lactams such as ε-caprolactam, CH-acidic compounds such as ethyl acetoacetate or malonic esters, amines such as diisopropylamine, heterocyclic compounds having at least one heteroatom such as mercaptans, piperidines, piperazines, pyrazoles, imidazoles, triazoles and tetrazoles, α-hydroxybenzoic esters such as glycolic esters, and hydroxamic esters such as benzyl methacrylohydroxamate. A single blocking agent or a mixture of different blocking agents may be used.

Particularly suitable blocking agents include c-caprolactam, acetone oxime, methyl ethyl ketoxime, acetophenone oxime, diisopropylamine, 3,5-dimethylpyrazole, 1,2,4-triazole, butyl glycolate, benzyl methacrylohydroxamate, and methyl p-hydroxybenzoate.

The general blocking reaction procedure is to add the isocyanate component to the reaction chamber to start with and then to add the blocking agent in portions. The reaction can be carried out without solvent or in the presence of suitable (inert) solvents. It is preferred, however, to operate without solvent. When operating in the absence of solvent the isocyanate component is heated to 90-130° C. At this temperature the blocking agent is added in a conventional manner. When the blocking agent has been added the reaction mixture is heated at 120° C. for about 1 to 2 h in order to complete the reaction. The blocking agent is added in amounts such that from 0.5 to 1.1 mol of blocking agent, preferably from 0.8 to 1 mol, preferably 1 mol, reacts per NCO equivalent of the isocyanate component. In order to accelerate the isocyanate polyaddition reaction customary catalysts of polyurethane chemistry, such as organic tin, zinc or amine compounds, for example, may be added in amounts of from 0.01 to 1% by weight, based on the overall mixture.

The solvent-free blocking reaction can also be performed continuously in a static mixer or preferably in a multiple-screw extruder, in particular a twin-screw extruder.

The total NCO content of the blocked crosslinker component A) is from 8 to 20% by weight, preferably from 9 to 17% by weight, more preferably from 10 to 15% by weight.

Thus the powder coating compositions of the invention may comprise crosslinkers based on blocked polyisocyanates, on blocked isocyanurates, and on uretdiones, alone or in a mixture. The starting components are preferably selected from IPDI, HDI and HMDI.

The auxiliaries and additives C) present in the powder coating compositions of the invention are for example leveling agents, pigments, and catalysts. They are normally included in amounts of 0.5-50% by weight.

### EXAMPLES

General Preparation Instructions for the Powder Coating Materials

To prepare the ready-to-use powder coating materials the polyester mixture, crosslinker, leveling agent(s), pigments, and any catalysts were mixed with one another at room temperature and the mixture was subsequently homogenized on an extruder or compounder at temperatures of 100-140° C. The ratio of resin to crosslinker is chosen such that there are from 0.6 to 1.2, preferably 0.8-1.0, reactive crosslinker groups available per reactive group of the resin.

After cooling the extrudate was fractionated, ground, and subsequently screened off to a particle size <100 μm. The powder produced by this operation was applied to degreased iron panels using an electrostatic powder spraying unit at 60 kV and baked at between 160 to 210° C. in a forced-air drying cabinet.

The formulations contained 30% by weight of titanium dioxide (e.g. Kronos 2160 from Kronos), 1% by weight of leveling agent (e.g. Resiflow PV 88 from Worlée-Chemie), 0.2-0.5% by weight of devolatilizer (e.g. benzoin from Merck-Schuchardt).

Ingredients:

1) (Semi)crystalline polyester B2 : Dynacoll 7390, OH number 32 mg KOH/g, (Degussa A G)

2) Preparation of the (semi)crystalline polyester B2: (COOH-functionalized)

The (semi)crystalline polyester B2 was prepared by reacting the commercially available crystalline hydroxyl-functionalized polyester Dynacoll 7390 (product of Degussa A G) with succinic anhydride. A 5 liter heatable stirred reactor was charged with 3500 g of Dynacoll 7390 (OH number 32; melting range 105-115° C.), which was melted, and then 210 g of succinic anhydride was added to the melt (about 160° C.) over the course of 10 minutes with stirring. The reaction mixture was subsequently heated at 180-210° C. for 2 hours. Thereafter the acidic polyester was discharged and cooled and the solid product (acid number 34 mg KOH/g) was comminuted.

1) Amorphous Polyesters:

Uralac P 875, acid number: 35 mg KOH/g, Tg: 56° C. (DSM, Netherlands)

Uralac P 6600, acid number: 33 mg KOH/g, Tg: 57° C. (DSM, Netherlands)

Uralac P 1580, OH number: 85 mg KOH/g, Tg: 51° C. (DSM, Netherlands)

2) Crosslinkers

ARALDIT PT 810, polyepoxide (Vantico)

VESTAGON HA 320, hydroxyalkylamide (Degussa A G)

VESTAGON B 1530, polyisocyanate caprolactam-blocked (Degussa A G)

VESTAGON BF 1540, polyisocyanate uretdione-based (Degussa A G)

3) Formulations:

### Example 1

Hydroxyalkylamide system

Baking conditions: 15 min, 180° C.

Gloss: 33 scale divisions at 60°

[symbol]

Erichsen cupping: 10 mm

Ball impact (direct/reverse): 120/80 in·lb

| Products | % by mass | Ingredients |
|---|---|---|
| Crosslinker | 3.50 | VESTAGON HA 320 |
| Amorphous polyester | 39.10 | URALAC P 875 |
| Semicrystalline polyester | 26.10 | B2) |
| Pigment TiO₂ | 30.00 | KRONOS 2160 |
| Leveling agent | 1.00 | RESIFLOW PV 88 |
| Devolatilizer | 0.30 | benzoin |

### Example 2

TGIC system

Baking conditions: 15 min, 180° C.

Gloss: 31 scale divisions at 60°

[symbol]

Erichsen cupping: 11 mm

Ball impact (direct/reverse): 130/80 in·lb

| Products | % by mass | Ingredients |
|---|---|---|
| Crosslinker | 5.00 | ARALDIT PT 810 |
| Amorphous polyester | 38.10 | URALAC P 6600 |
| Semicrystalline polyester | 25.40 | B2) |
| Pigment TiO₂ | 30.00 | KRONOS 2160 |
| Leveling agent | 1.00 | RESIFLOW PV 88 |
| Devolatilizer | 0.50 | benzoin |

### Example 3

Polyurethane system (caprolactam-blocked)

Baking conditions: 12 min, 200° C.

Gloss: 15 scale divisions at 60°

[symbol]

Erichsen cupping: 11 mm

Ball impact (direct/reverse): 60/20 in·lb

| Products | % by mass | Ingredients |
|---|---|---|
| Crosslinker | 15.80 | VESTAGON B 1530 |
| Amorphous polyester | 31.60 | URALAC P 1580 |
| Semicrystalline polyester | 21.10 | B1) |
| Pigment TiO₂ | 30.00 | KRONOS 2160 |
| Leveling agent | 1.00 | RESIFLOW PV 88 |
| Devolatilizer | 0.50 | Benzoin |

### Example 4

Polyurethane system (uretdione-based)

Baking conditions: 12 min, 200° C.

Gloss: 32 scale divisions at 60°

[symbol]

Erichsen cupping: 11.5 mm

Ball impact (direct/reverse): 100/70 in·lb

| Products | % by mass | Ingredients |
|---|---|---|
| Crosslinker | 15.20 | VESTAGON BF 1540 |
| Amorphous polyester | 32.00 | URALAC P 1580 |
| Semicrystalline polyester | 21.30 | B1) |
| Pigment TiO₂ | 30.00 | KRONOS 2160 |
| Leveling agent | 1.00 | RESIFLOW PV 88 |
| Devolatilizer | 0.50 | benzoin |

German application 10257216.8 filed on Dec. 7, 2002 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A powder coating composition comprising
A) one or more crosslinkers
and
B) one or more polyesters containing one or more COOH groups, OH groups, or both COOH and OH groups, wherein the polyester comprises
B1) from 10 to 80% by weight of at least one amorphous polyester based on the total weight of the polyester,
B2) from 20 to 90% by weight, based on the total weight of the polyester, of at least one (semi)crystalline polyester comprising polymerized units of from 50 to 100 mol % of at least one of succinic acid, adipic acid, sebacic acid or dodecanedioic acid, anhydride or ester thereof, and from 50 to 100 mol % of at least one of monoethylene glycol, butane-1,4-diol or hexane-1,6-diol,
wherein the polyester has an OH number of from 0 to 200 mg KOH/g and a COOH number of from 0 to 150 mg KOH/g, wherein at least one of the COOH number or OH number is greater than zero, and from 0.6 to 1.2 reactive groups of the crosslinker is present per functional group of the polyester.

2. The powder coating composition as claimed in claim 1, further comprising C.) 1-50% by weight of one or more auxiliaries and additives.

3. The powder coating composition as claimed in claim 1, wherein the polyester comprises:
B1) 60-70% by weight of at least one amorphous polyester and
B2) 30-40% by weight of at least one (semi)crystalline polyester.

4. The powder coating composition as claimed in claim 1, wherein the amorphous polyester B1) has a COOH number, OH number or both a COOH number and an OH number of 15-200 mg KOH/g, a Tg of 35-85° C., a melting range of 60 to 110° C., a hydroxyl number, an acid number or both an hydroxyl number and an acid number of <10 mg KOH/g, and a molar mass of from 2,000 to 7,000.

5. The polyester powder coating material as claimed in claim 4, wherein the polyester B1) comprises polymerized units of one or more selected from the group consisting of isophthalic acid, phthalic acid, adipic acid, azelaic acid, sebacic acid, dodecanedioic acid, trimellitic acid, hexahydroterephthalic acid, hexahydrophthalic acid, succinic acid and 1,4-cyclohexanedicarboxylic acid.

6. The polyester powder coating material as claimed in claim 5, wherein the amorphous polyester comprises one or more linear, aliphatic or cycloaliphatic diols.

7. The polyester powder coating material as claimed in claim 6, comprising one or more polymerized units selected from the group consisting of monoethylene glycol, diethylene glycol, Dicidol, neopentylglycol hydroxypivalate, neopentylglycol, cyclohexanedimethanol, butane-1,4-diol, pentane-1,5-diol, pentane-1,2-diol, hexane-1,6-diol and nonane-1,9-diol.

8. The polyester powder coating material as claimed in claim 1, wherein the (semi)crystalline polyester B2) has a COOH number, an OH number or both a COOH number and an OH number of 15-150 mg KOH/g, a melting point of between 60 and 130° C., a glass transition temperature <−10° C., and a weight average molecular weight of between 1,800 and 6,500.

9. The polyester powder coating material as claimed in claim 8, wherein the (semi)crystalline polyester B2) comprises one or more of succinic acid, adipic acid, sebacic acid, or dodecanedioic acid in an amount of at least 50 mol %, based on the total amount of all carboxylic acids.

10. The polyester powder coating material as claimed in claim 9, comprising not more than 50 mol %, of other aliphatic, cycloaliphatic or aromatic dicarboxylic acids.

11. The polyester powder coating material as claimed in claim 10, comprising one or more of glutaric acid; azelaic acid; 1,4-, 1,3- or 1,2-cyclohexanedicarboxylic acid; terephthalic acid; or isophthalic acid.

12. The polyester powder coating material as claimed in claim 9, comprising one or more of monoethylene glycol, butane-1,4-diol, or hexane-1,6-diol in an amount of at least 80 mol %, based on the total amount of all polyols.

13. The polyester powder coating material as claimed in claim 12, comprising not more than 20 mol % of other aliphatic polyols, cycloaliphatic polyols, linear polyols or branched polyols.

14. The polyester powder coating material as claimed in claim 13, comprising one or more of diethylene glycol, neopentylglycol hydroxypivalate, neopentylglycol, cyclo-hexanedimethanol, pentane-1,5-diol, pentane-1,2-diol, nonane-1,9-diol, trimethylolpropane, glycerol or pentaerythritol.

15. The polyester powder coating material as claimed in claim 1, where the crosslinker A) is at least one of TGIC, a TGIC compound, a β-hydroxyalkylamide, or a combination thereof.

16. The polyester powder coating material as claimed in claim 15, comprising one or more β-hydroxyalkylamides of the formula 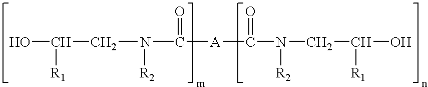
where R₁ is hydrogen, an aromatic radical or a C₁-C₅ alkyl group, R₂ is hydrogen, an aromatic radical, a C₁-C₅ alkyl group or 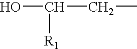
and A is a chemical bond or a monovalent or polyvalent organic group selected from the group consisting of saturated, unsaturated and aromatic hydrocarbon groups, and substituted hydrocarbon groups having from 2 to 20 carbon atoms, m is 1 to 2, n is 0 to 2, and m+n is at least 1.

17. The polyester powder coating material as claimed in claim 16, comprising 2-10% by weight of a β-hydroxyalkylamide.

18. The polyester powder coating material as claimed in claim 1, wherein the crosslinker comprises one or more polyisocyanates having a functionality of ≧1.7.

19. The polyester powder coating material as claimed in claim 18, wherein the polyisocyanates are externally blocked, internally blocked or both internally and externally blocked.

20. The polyester powder coating material as claimed in claim 18, wherein the polyisocyanates comprise one or more polymerized monomer units selected from the group consisting of IPDI, HDI and HMDI.

21. The polyester powder coating material as claimed in claim 18, wherein the polyisocyanates comprise one or more polymerized units selected from the group consisting of a urethane group, an isocyanurate group and an uretdione group.

22. A method comprising:
applying one or more polyester powder coating materials on a substrate to form a coating with a matt appearance,
wherein the polyester powder coating material comprises:
A) one or more crosslinkers
and
B) one or more polyesters containing one or more COOH groups, OH groups, or both COOH and OH groups, wherein the polyester comprises
B1) from 10 to 80% by weight of at least one amorphous polyester based on the total weight of the polyester,
B2) from 20 to 90% by weight, based on the total weight of the polyester, of at least one (semi)crystalline polyester comprising polymerized units of from 50 to 100 mol % of at least one of succinic acid, adipic acid, sebacic acid or dodecanedioic acid, anhydride or ester thereof, and from 50 to 100 mol % of at least one of monoethylene glycol, butane-1,4-diol or hexane-1,6-diol, and
wherein the polyester has an OH number of from 0 to 200 mg KOH/g and a COOH number of from 0 to 150 mg KOH/g, wherein at least one of the COOH number or OH number is greater than zero, and from 0.6 to 1.2 reactive groups of the crosslinker is present per functional group of the polyester.
